(19) United States
(12) Patent Application Publication
(10) Pub. No.: US 2026/0285270 A1
(43) Pub. Date: Sep. 24, 2026

(54) Lift Axle Braking System

(71) Applicant: KB Intellectual Property GmbH & Co. KG, Pullach (DE)

(72) Inventors: Christopher H. Hutchins, Bay Village, OH (US); Alexander J. Augoustidis, Avon Lake, OH (US)

(73) Assignee: KB Intellectual Property GmbH & Co. KG, Pullach (DE)

(21) Appl. No.: 19/083,994

(22) Filed: Mar. 19, 2025

(51) Int. Cl. B60T 8/1761; B60T 8/17; B60T 8/1763; B60T 15/02

(52) U.S. Cl. CPC B60T 8/1761; B60T 8/1701; B60T 8/1763; B60T 15/027; B60T 2250/04

(57) ABSTRACT

A lift axle can be provided on a truck during or after manufacturing to allow the truck to carry more load. The lift axle can be selectively lifted above the road (e.g., when the truck is empty) and lowered onto the road (e.g., when carrying load requiring an extra axle). There are various challenges in designing a braking system for a lift axle. The embodiments presented herein provide a lift axle brake system that can overcome these challenges.

### BACKGROUND

In the North American commercial vehicle market, trucks and tractors are often equipped with liftable axles. These liftable axles are used to increase the load carrying capacity of the vehicle while remaining in compliance with regulatory limits, which may vary from state-to-state. The liftable characteristic of the axles allows them to be lowered when the vehicle is carrying load that would exceed either the gross axle weight rating (GAWR) of the fixed axles or the regulatory limit for load on the fixed axles. The axles may then be lifted in other conditions to reduce operating costs (e.g., related to wear or tolls) or to allow backing in the case of castering self-steering axles, which only self-steer in the forward direction.

Lift axles are sometimes added to the vehicle during its original equipment manufacturer (OEM) manufacturing process, and in this case, the brake controller may be configured to control the brakes on these axles using control strategies designed to take vehicle speed, axle position, axle load, and other information as inputs. In other cases, the axles are added after the manufacture of the original vehicle, often by companies called “body builders” which typically install a body and other equipment on the bare chassis to form a vehicle suitable for use in a particular vocation (e.g., concrete mixer or dump truck). In these cases, the body builder may not have the privileges, tools, skills, or information needed to configure the brake controller for compatibility with the liftable axles.

### BRIEF DESCRIPTION OF THE DRAWINGS

FIG. 1 is a diagram of a braking system of a towing vehicle of an embodiment.

FIG. 2 is a diagram of a braking system of a towing vehicle of an embodiment that uses a towed vehicle anti-lock brakes system (TABS) on a lift axle.

FIG. 3 is a diagram of a braking system of a towing vehicle of an embodiment that uses a controller area network (CAN)-connected lift axle brake system (LABS) on a lift axle.

FIG. 4 is a diagram of a braking system of a truck of an embodiment.

FIG. 5 is a diagram of a braking system of a truck of an embodiment that uses a TABS on a lift axle.

FIG. 6 is a diagram of a braking system of a truck of an embodiment that uses a CAN-connected LABS on a lift axle.

### SUMMARY

In one embodiment, a brake system is provided comprising: an electro-pneumatic module (EPM) configured to allow pressurized air to flow to a brake of a non-lift axle of a vehicle in response to movement of a brake pedal of the vehicle; and a lift axle brake sub-system for a lift axle of the vehicle, the lift axle brake sub-system comprising: at least one brake; and a valve configured to selectively open to allow pressurized air to flow to the at least one brake of the lift axle of the vehicle; wherein a control port of the valve is coupled with a delivery port of the EPM, and wherein the valve is configured to receive pressurized air from the EPM in response to movement of the brake pedal, which causes the valve to open and allow pressurized air to flow to the at least one brake of the lift axle of the vehicle, and wherein the at least one brake of the lift axle of the vehicle is controlled to a same pressure provided to an anti-lock braking system (ABS) modulator on the non-lift axle of the vehicle.

In another embodiment, a brake system is provided comprising: an electro-pneumatic module (EPM) configured to allow pressurized air to flow to a brake of a non-lift axle of a vehicle in response to movement of a brake pedal of the vehicle; and a lift axle brake sub-system for a lift axle of the vehicle, the lift axle brake sub-system comprising: at least one brake; and a towed vehicle anti-lock brake system (TABS) comprising a valve configured to allow pressurized air to flow to the at least one brake of the lift axle of the vehicle; wherein a control port of the TABS is coupled with a delivery port of the EPM, wherein the TABS is configured to receive pressurized air from the EPM in response to movement of the brake pedal, which causes the TABS to allow pressurized air to flow to the at least one brake of the lift axle of the vehicle, and wherein the TABS is configured to use an output of a wheel speed sensor on the non-lift axle of the vehicle to perform closed-loop slip control on the lift axle of the vehicle.

In yet another embodiment, a brake system is provided comprising: an electro-pneumatic module (EPM) configured to allow pressurized air to flow to a brake of a non-lift axle of the vehicle in response to movement of a brake pedal of a vehicle; and a lift axle brake sub-system for a lift axle of the vehicle, the lift axle brake sub-system comprising: at least one brake; and a lift axle brake system (LABS) comprising a valve configured to allow pressurized air to flow to the at least one brake of the lift axle of the vehicle; wherein a control port of the LABS is coupled with a delivery port of the EPM, and wherein the LABS is configured to receive pressurized air from the EPM in response to movement of the brake pedal, which causes the LABS to allow pressurized air to flow to the at least one brake of the lift axle of the vehicle; and wherein the LABS is further configured to receive information from an electronic braking system controller and adjust application of the at least one brake on the lift axle in response to the information.

Other embodiments are possible, and each of the embodiments can be used alone or together in combination.

### DETAILED DESCRIPTION

### Introduction

The following embodiments relate to a brake system for a lift axle. As mentioned above, the amount of load a truck can carry is typically constrained by the number of axles on the truck. A lift axle can be provided on a truck during or after manufacturing to allow the truck to carry more load. The lift axle can be selectively lifted above the road (e.g., when the truck is empty) and lowered onto the road (e.g., when carrying load requiring an extra axle).

Embodiments relate to braking systems for vehicles. For example, embodiments relate to a system for controlling wheel brakes on a lift axle of a vehicle in which wheel brakes on other axles in the vehicle are controlled using an electronic-over-air brake subsystem (hereinafter referred to as electronic braking system (EBS)). In this document, one version of EBS will be referred to as Global Scalable Brake Control (GSBC®).

The use of electronic braking systems to control wheel brakes in vehicles is continuously increasing. As compared to conventional fluid control of wheel brakes, electronic braking systems offer several advantages. Electronic braking systems shorten the response time between a brake command and application of the brakes because electrical control signals travel faster than fluid control signals. Electronic braking systems also allow more accurate control of brake pressure due to the use of pressure sensors and other feedback systems. Electronic brake systems also allow brake pressure to be set independently of the position of operator controls such as brake pedals.

There are various challenges in designing a braking system for a lift axle. For example, certain brake controllers (e.g., GSBC® controllers) may require a detailed configuration of the vehicle to be programmed into it. This can be a challenge when a lift axle is installed on a truck aftermarket by a facility or a technician who does not know how to program the controller and/or what data to program into the controller. The following embodiments provide a lift axle brake system that can overcome these challenges. Before turning to these embodiments, the following section provides a brief overview of an example braking system.

### Overview of Example Braking System

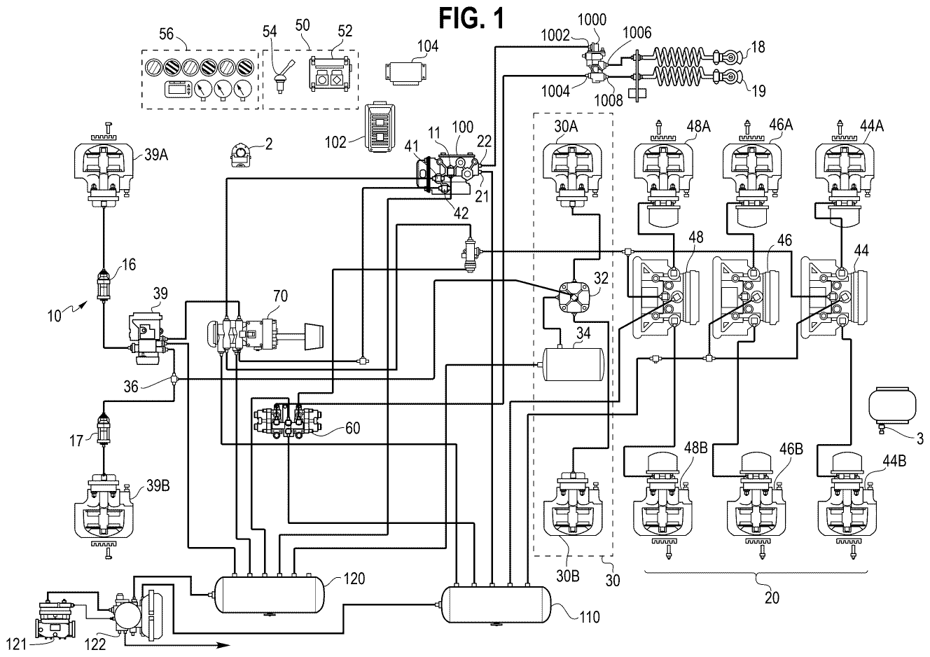

Turning now to the drawings, FIG. 1 is a block diagram of a vehicle of an embodiment. The vehicle can take any form. In one example embodiment, the vehicle is a towing vehicle that is capable of towing a towed vehicle or other towed vehicle and has a front undriven (steer) axle 10, one or more rear axles 20 (at least one of which can be a driven axle), and a lift axle 30. While a single lift axle is shown in FIG. 1, it should be understood that the vehicle can comprise more than one lift axle with appropriate modifications made to the lift axle braking system discussed below. Also, as will be explained in more detail below, the vehicle can take other forms, such as, but not limited to, a truck that is not towing a towed vehicle.

As shown in FIG. 1, in this embodiment, the braking system comprises an electronically-controlled electronic trailer pressure control module 100 (referred to herein as an eTPCM), a braking controller 102, and an overall vehicle controller 104, As used herein, a “controller” (or an “electronic control unit”) can comprise one or more processors that can execute computer-readable program code having instructions (e.g., modules, routines, sub-routine, programs, applications, etc.) that, when executed by the one or more processors, individually or in combination, cause the one or more processors to perform certain functions, such as some or all of those discussed herein. The computer-readable program code can be stored in a non-transitory computer-readable storage medium, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. The one or more processors can also take the form of a purely-hardware implementation (e.g., an application-specific integrated circuit (ASIC)).

The braking system of this embodiment also comprises a dash control module 50 that may comprise of a parking controller 52 and/or an electronic towed vehicle hand control 54, dash displays 56, a park valve module 60, a foot brake module 70, a rear service air reservoir 110, and a front service air reservoir 120. In one embodiment, this braking sub-system is located on a towing vehicle and pneumatically communicates with a braking system of a towed vehicle via gladhands 18, 19. Other components of the vehicle's braking system (such as the towing vehicle's service and parking brakes) are not shown to simplify the drawing.

The rear and front service reservoirs 110, 120 of the braking system are configured to store pressurized air that is supplied by a compressor 121 and heated (e.g., in colder climates) by a heater 122, and the pressurized air in these reservoirs 110, 120 is used to supply various braking components on the towing vehicle and the towed vehicle. In this embodiment, the rear service reservoir 110 is part of a braking circuit that provides pneumatic pressure to the braking components of the rear and lift axles 20, 30 of the towing vehicle, and the front service reservoir 120 is part of a separate braking circuit that provides pneumatic pressure to the braking components of the front axle 10 of the towing vehicle. Accordingly, the braking system of the towing vehicle of this embodiment has two isolated braking circuits. Depending on the configuration of the vehicle, either reservoir 110, 120 could be used to supply liftable axle(s).

The rear and front service reservoirs 110, 120 are coupled with respective valves in the foot brake module 70 via air hoses (lines) or the like. The foot brake module 70 comprises a brake pedal (e.g., a suspended pedal, where the valve is mounted above the pedal, or a treadle, which pivots directly on the valve mounted below the treadle). Actuation of the brake pedal causes the two valves to open proportional to the amount of actuation of the brake pedal, which caused pneumatic pressure supplied from the rear and front reservoirs 110, 120 to be supplied out of outlet ports of the foot brake module 70 in proportion to the amount of actuation of the brake pedal. The outlet ports of the foot brake module 70 are coupled with service brake components (not shown) of the towing vehicle.

The foot brake module 70 can also provide signals to the braking controller 102 that represent the amount of actuation of the brake pedal. For example, in one embodiment, the foot brake module 70 comprises one or more sensors that measure how much stroke a driver indicates by pressing the brake pedal and transmit electronic signals representing that displacement, which represents a driver brake demand, to the braking controller 102. In one embodiment, the foot brake module 70 contains two sensors, one that increments up and one that increments down as the brake pedal is pressed. These two opposing signals can be used as an error detection mechanism, as the braking controller 102 can detect an error if the two signals it receives from the foot brake module 70 are not opposing. Also, in one embodiment, the foot brake module 70 generates a signal even when the brake pedal is not pressed (such signal would represent zero braking). That way, if the braking controller 102 receives no signal whatsoever from the foot brake module 70, the braking controller 102 can assume there is a fault or error in the foot brake module 70 or communication channel (which, in one embodiment, can be a direct, point-to-point communication channel, such as a universal asynchronous receiver-transmitter (UART) link). It should be understood that any suitable implementation of a foot brake module can be used, and a foot brake module can contain more or different components than those described herein.

In operation, when the brake controller 102 receives electronic brake request signals, the brake controller 102 maps the signals representing the displacement to a requested deceleration and commands to electro-pneumatic modules (EPMs) 39, 44, 46, 48 on the undriven and rear axles 10, 20 to apply the appropriate amount of pressure needed to achieve that deceleration given various variables, such as, but not limited to, vehicle weight, weight distribution, whether a towed vehicle is present, and driving conditions. (The braking of the lift axle 30 will be discussed in a subsequent section.) The brake controller 102 can take any suitable form, such as, but not limited to, an electronic control unit that provides instructions for mechatronic valves to activate brakes.

In an EBS, relays and modulators on an axle can be combined into an EPM, which is capable of electronically applying, holding, and releasing air to decelerate a wheel end of the axles. The EPMs 39, 44, 46, 48 can cause the vehicle to decelerate in any suitable way. For example, in the embodiment shown in FIG. 1, the EPMs 44, 46, 48 on the second set of axles 20 are two-channel EPMs. EPM 44 communicates with friction brakes (here, air disc calipers 44A, 44B) on each braked wheel end of the steer axle, while EPMs 46, 48 control air disc calipers 46A, 46B, 48A, 48B on each braked wheel end of the optional axle. While disc brakes are shown in the illustrated example, it is to be understood that any foundation brake technology compatible with a pneumatic brake system is also contemplated. The EPM 39 on the undriven axle 10 in this example is a one-channel EPM that communicates, via modulators 16, 17, with air disc calipers 39A, 39B on each braked wheel end of the undriven axle, Rear and front reservoirs 110, 120 can provide pneumatic supply pressure to the EPMs 39, 44, 46, 48. The system also includes a steer-angle sensor 2, which can detect the angle of the steering wheel (e.g., to detect if the vehicle is driving straight or is driving through a curve), as well as an axle load sensor 3.

Pneumatic signals for controlling the service and parking brakes can be applied to the towed vehicle via the pneumatic control and supply lines 18, 19. This allows the braking system to control braking of the towed vehicle towed by the towing vehicle. That is, in addition to applying pressurized air to the service brakes of the towing vehicle, pressurized air from the foot brake module 70 is also sent to the towed vehicle via gladhand 18 to provide a control signal to actuate brakes on the towed vehicle. In this embodiment, gladhand 19 is used to supply pressurized air from the rear or front service reservoirs 110, 120 to the towed vehicle, and that air is used to supply pressure to the control valves that deliver service brake air to the brakes on the towed vehicle in response to pneumatic control signals received via gladhand 18. Pressurized air from gladhand 19 is also used to release the parking brakes of the towed vehicle. In this embodiment, the towed vehicle has spring brakes that place the towed vehicle in a parked state in the absence of pressurized air. To release the parking brakes on the towed vehicle, a driver can cause pressurized air to flow on the supply line of gladhand 19, and that air is applied to the spring brakes in the towed vehicle to un-park the towed vehicle. For example, the dash control module 50 can comprise a push-pull button that, when pushed in, causes the park valve module 60 to open. (Another push-pull button on the dash control module 50 can cause the park valve module 60 to apply air to release the spring parking brakes in the towing vehicle.) The park valve module 60 receives pressurize air from the rear and front service reservoirs 110, 120, and the greater pressure is applied from the park valve module 60 in response the push-pull button being pushed in. That air is sent, via gladhand 19, to the towed vehicle to release the spring parking brakes. The park valve module 60 can also detect the pressure being supplied out of gladhand 19. If that pressure is not above a threshold pressure, the valve in the park valve module 60 closes, preventing supply air from being provided out of gladhand 19.

As mentioned above, in addition to un-parking the spring brakes of the towed vehicle, the pressurized air on the service line can be used to actuate the service brakes of the towed vehicle in response to a pneumatic control signal supplied on the control line to gladhand 18. In one embodiment, the pressurized air from gladhand 19 is used to fill reservoir(s) in the towed vehicle, and the pneumatic control signal supplied on gladhand 18 causes air to flow from the reservoir(s) to the braking components on the towed vehicle. The eTPCM 100 can be used to supply the pneumatic control signal to the towed vehicle.

As shown in FIG. 1, the eTPCM 100 comprises inlet ports 41, 42 (with single check valves, not shown) that receive pressurized air from the rear and front service reservoirs 110, 120 in response to actuation of the brake pedal of the foot brake module 70. The eTPCM 100 also receives pressurized air from the front service reservoir 120 via port 11 (the pressure from the service reservoirs is proportionally applied). Based on the amount of pressurized air received from the foot brake module 70 and/or control signals from the braking controller 102 for electronic braking, the eTPCM 100 causes a proportional amount of pressurized air received from the rear and front service reservoirs 110, 120 to output at port 22, which is coupled with the control line that leads to gladhand 18. This supplied air is the control air sent to the towed vehicle to control the towed vehicle's braking system. The eTPCM 100 also comprises port 21, which is coupled with the rear service reservoir 110.

A towing vehicle protection valve (TPV) 1000 comprises two (2) input ports including i) a towing vehicle control port 1002 (e.g., a tractor control port) and ii) a towing vehicle supply port 1004 (e.g., a tractor supply port) that receive pressurized air from the eTPCM outlet port 22 and the parking control valve 60, respectively. The TPV 1000 also comprises two (2) delivery ports including i) a towed vehicle control port 1006 (e.g., a trailer control port) and ii) a towed vehicle supply port 1008 (e.g., a trailer supply port) that are coupled to, and fluidly communicate with, the gladhands 18, 19, respectively, of the towing vehicle. The TPV 1000, depending upon the pressure present at the towing vehicle supply port 1004 and the towed vehicle supply port 1008 may be used to prevent or control the venting control air when a towed vehicle is not connected to the towing vehicle. This is referred to herein as “towing vehicle protection.” Although the illustrated embodiment shows the TPV 1000 and eTPCM 100 as separate devices, it to be understood that the TPV 1000 and the eTPCM 100 can be integrated into a single device (e.g., the TPV 1000 may be integrated into the eTPCM 100).

### Overview of Challenges With Lift Axle Braking

As mentioned above, the vehicle in this example comprises a lift axle 30. Before discussing the braking system used in this embodiment to brake the lift axle 30, this section provides an overview of the challenges involved in lift axle braking.

It may be desired for the brake controller 102 to control the braking of the lift axle 30 as it does with the other axles 10, 20. However, some brake controllers, such as Global Scalable Brake Control (GSBC®) controllers, have a limited number of axles that it can control via EPMs to control the air pressure to each wheel end. Further, electronic brake system (EBS) controllers typically must be configured for each unique vehicle application, ideally at end-of-line at the vehicle manufacturer's plant. Determining the correct configuration may involve analysis, testing, and simulation to determine the correct end-of-line configuration.

These characteristics of EBS can conflict with the desires of the North American market, in which the vehicle original equipment manufacturers (OEMs) want legally-compliant performance with a minimum amount of application work and a minimum incremental expense for adding lift axles to a vehicle. Therefore, there is a desire to produce vehicles with lift axles but no additional EPMs or wheel speed sensors.

Furthermore, trucks are often built by the OEM with no lift axles and then purchased to be modified for a specific vocation. This typically involves “body builders” installing equipment such as lift axles and other equipment. Most, if not all, body builders do not possess the technical equipment or experience to test, calibrate, and reconfigure the EBS brake controller to accommodate additional axles or other vehicle configuration changes. And, in some cases, the number of lift axles installed may be beyond what can be accommodated by an electronic braking system using the current system design.

Electronic braking systems are typically configured so the controller (e.g., the electronic control unit (ECU)) has an accurate definition of the vehicle in terms of the number of axles present, the type of axle (e.g., steer, drive, liftable), the friction brakes on each axle, and the air-pressure-versus-load characteristic of the air suspension, if so equipped. This vehicle definition enables the system to use a multitude of inputs and sophisticated algorithms to determine the appropriate amount of brake pressure to be delivered to each wheel end. These inputs include total wheel speed, vehicle mass, axle load, friction brake performance, powertrain retardation performance, and driver's braking demand.

For vehicles equipped as built by the vehicle OEM, such ECU configuration can be accomplished using a combination of the OEM's bill of materials from the vehicle assembly process, in combination with a programming station that can set values for the needed ECU parameters at the end of the manufacturing line, also called End of Line (EOL) configuration. Valid vehicle configurations are limited by the total amount of discrete input-output (IO) for the EBS ECU and EPMs, as well as software characteristics.

So, in some environments, the brake controller may need to accommodate the following example features:
1. Lift axles that are installed in the OEM plant. These axles are not equipped with wheel speed sensors. This lack of wheel speed sensors may prevent addition of an EPM to the lift axle.
2. An expansive set of vehicle configurations in terms of lift axle quantity, type (e.g., self-steering vs. non-steering), location (forward or aft of the drive axles), friction brakes (e.g., drum vs. disc), and tires.
3. Lift axles that may be equipped with wheel speed sensors and towed vehicle anti-lock brakes system (TABS) for slip control, which is a common practice at some “body builders.”

An example minimum level of performance that may be required can be characterized as:
1. All lift axles must be braked.
2. All lift axles must be able to receive full reservoir pressure if commanded by the driver.
3. Pneumatic brake apply and release performance must be consistent with the requirements of Federal Motor Vehicle Safety Standard (FMVSS) No. 121, as applicable, which requires a vehicle to comply with certain performance limits.
4. Brake activation on the lift axles must not unacceptably degrade directional control of the vehicle.

An example enhanced level of performance that may be desired in some applications include:
1. Brake actuations conducted in a way that will minimize damage to tires.
2. Compatibility with slip control via a TABS controlling one or more lift axles.

Given the high degree of variability in potential vehicle configurations and the high degree of variability in braking performance from the lift axles on a given vehicle (because of variable normal force on the axles), the GSBC® system may need to be able to automatically compensate during service braking, without diagnostics being triggered or other errors occurring.

One potential braking strategy involves tailoring the vehicle characterizations in real-time based on measurement of the lift axle loads using air suspension pressure measurements. Although this approach is possible, it may require software changes and application engineering that may be extensive, resulting in a costly solution that may have little advantage in performance relative to today's lift axle control. Furthermore, this strategy may likely not be able to accommodate the entire gamut of lift axle configurations on North American vehicles today.

### Example Lift Axle Braking System

Several control methods can be used for air brakes on liftable axles. For example, U.S. patent application Ser. No. 18/387,214, which is hereby incorporated by reference herein, describes a lift axle braking system that is based on a brake system used to control the brakes on a towed vehicle. As described therein, a vehicle can be equipped with an EBS brake controller that uses the trailer control channel to activate the service brakes on the liftable axle according to an existing brake control strategy for trailers. This can involve calculating a suitable brake pressure given the estimated load on the trailers, the maneuver being conducted, and other inputs that may vary depending on the vehicle OEM and application.

The following embodiments provide another control method, in which the air brakes on a liftable axle are controlled by air supplied by an EPM of an undriven axle. One example of this embodiment is shown in FIG. 1. With reference again to FIG. 1, a T-connector 36 (other connectors can be used) is placed on the air line that provides pressured air from the EPM 39 to the air disc caliper 39B on the braked wheel end of the undriven axle. Another air line pneumatically connects the base of the T-connector 36 and a valve (e.g., a relay valve) 32 in the lift axle. (While the valve 32 in this example takes the form of a relay valve, it should be noted that any suitable type of valve can be used, including, but not limited to, quick release valves or other valves.) In this example, actuation of the service brakes of the vehicle (e.g., by movement of the foot brake) causes a pneumatic control signal to be supplied from the EPM 39, which causes pressurized air to be supplied to both the air disc caliper 39B on the braked wheel end of the undriven axle (to cause braking of that wheel end) and the relay valve 32 (to control braking on the lift axle 30). The pressurized air received by the relay valve 32 acts as a control signal to cause the relay valve 32 to open, allowing pressurized air in a tank (reservoir) in the lift axle sub-system 30 to flow to the air disc calipers 30A, 30B on each braked wheel end of the lift axle 30 to brake the lift axle 30.

This example can be used with an electronic braking system (EBS), where the front axle service brake pressure is provided by a single channel EPM, which provides brake pressure to the wheel ends via ABS modulators, which are used to regulate the wheelslip on each wheel end independently. In the case of EBS, the output of the front axle EPM is to be used to control the service brakes on the lift axles. This may be in combination with a mechatronic valve that is capable of monitoring data provided by the EBS and altering its control of the lift axle brakes according to the operating conditions of the vehicle and the brake interventions being performed by the EBS. By connecting the delivery port of the steer axle EPM 39 to the control port of the relay valve 32 on the liftable axle, the brakes on the liftable axle are controlled to the same pressure provided to anti-lock braking system (ABS) modulators on the steer axle(s). Using a relay valve on the liftable axle can reduce the volume of air needed to control the brakes on each axle.

This configuration can function well for a variety of conditions including normal service braking, RSP (Roll Stability Program), ATC (Automatic Traction Control), and XBR (External Brake Request). However, it may have limitations in that during some yaw control (YC) interventions, the liftable axles may receive brake pressures approaching the full reservoir pressure of the brake system, this architecture may still provide acceptable vehicle dynamic control given the following:
1. Yaw control interventions do not occur often on high-friction surfaces, and when they do, they are often in combination with a roll stability intervention, which has the intent of reducing vehicle speed. In these cases, application of the lift axle brakes is consistent with the priority of reducing vehicle speed and is unlikely to cause wheel locking because of the high-friction condition.
2. During yaw control interventions on low-friction surfaces, locking of the wheels on the liftable axles should have a minimal yaw moment contribution to the vehicle. This is because:
a. The low-friction condition limits the forces generated by the tires.
b. The liftable axles typically caster, resulting in a small slip angle for the tires, meaning little cornering force is generated by these axles.
c. The valves would deliver equal pressure to the left and right wheel ends of the liftable axle. Therefore, assuming little friction variation between the left and right tires, the yaw moments created by the braking force of the rolling tires would tend to oppose each other.
d. If the wheels were to lock, tire forces would be approximately tangent to the arc of travel of each wheel.

Therefore, except in the case of very large slip angles, the yaw moments created by the two tires should tend to oppose each other.
3. In the case of automated braking during split-mu conditions (e.g., XBR), the yaw moment created from the force difference between the two wheels would be opposed by the lateral forces of the rolling tires on the fixed axles, which are under slip regulation by the EBS.
a. Vehicles equipped with liftable axles typically have a long wheelbase, which improves their stability in such situations.
b. Automated brake applications are designed to regulate wheel-slip on the fixed axles such that there is sufficient lateral force available to maintain vehicle stability over a wide range of conditions.
c. The yaw moment created by the liftable axles would be bounded by that created by a full-pedal application of the service brakes, which is a use case that vehicles with liftable axles already tolerate acceptably.

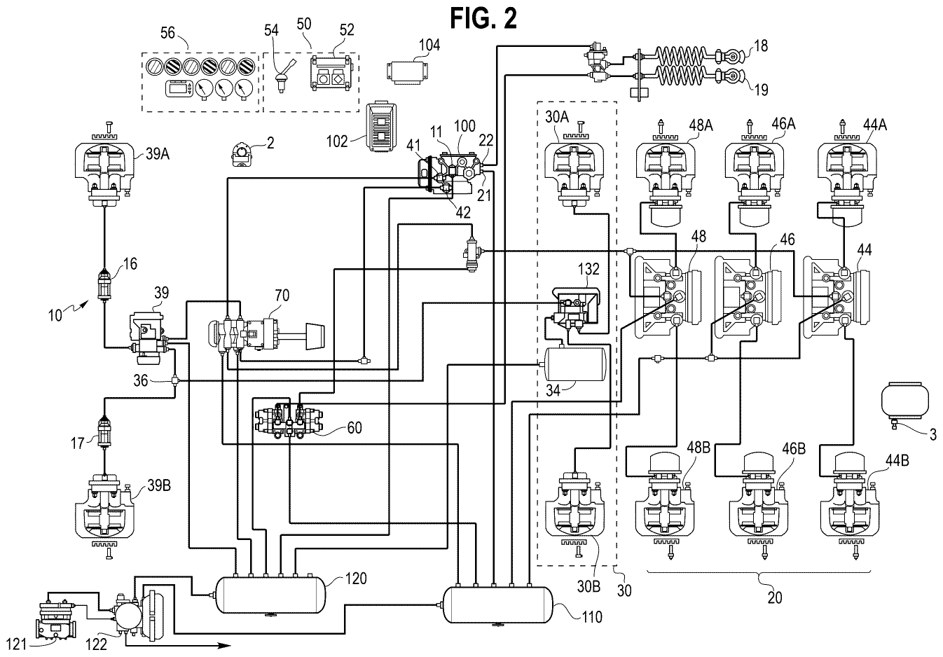

In another embodiment (shown in FIG. 2), instead of the pneumatic control signal being supplied to a relay valve, it is supplied to a towed vehicle anti-lock brakes system (TABS) 132 on the lift axle 30. The TABS 132 can use wheel speed sensors to perform closed-loop slip control on the axle(s). That is, the TABS 132 can enhance performance of the system by regulating wheel slip on the liftable axles, provided wheel speed sensors are installed on at least one controlled axle. While this embodiment may still send high pressures to the liftable axles during yaw control interventions, locking wheels would largely be prevented.

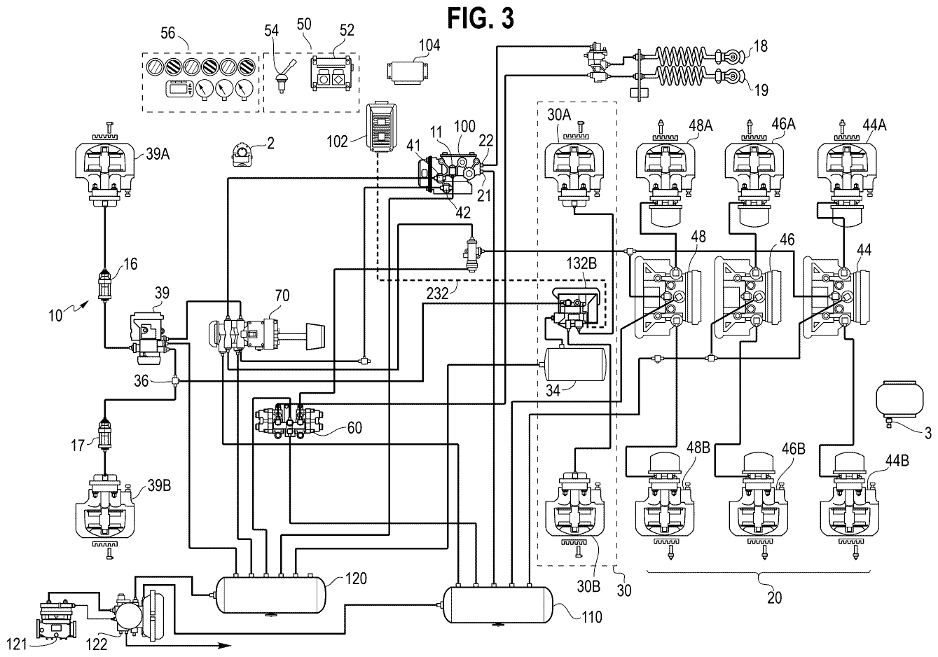

In yet another embodiment (shown in FIG. 3), the control port of the steer axle EPM 39 is connected to a device similar to a TABS but with altered functionality. This device is referring to herein as a Lift Axle Brake System (LABS) 132B and is connected to at least one data network on the vehicle. For example, the LABS 132B can be connected to the brake controller 102 (e.g., via a trailer controller area network (CAN) 232), similar to the connection used for European towing-towed vehicles. This would provide advantages in the speed and accuracy of brake application and would potentially achieve comparable performance to direct control of the lift axles by GSBC® EPMs.

In this embodiment, the LABS 132B is configured to receive information about the vehicle operating conditions and EBS activity. The control strategy employed by the LABS 132B can include receiving information to assess the type of braking activity and adjust application of the brakes on the lift axle accordingly. Primarily, the application of liftable axle brakes during yaw control interventions would be prevented. Other deviations from the steer axle brake pressure may be implemented depending on the details of the vehicle application. The control strategy may also receive vehicle speed information from the EBS brake controller or other ECUs on the vehicle and use that speed information as a reference speed to enhance wheel-slip regulation. This embodiment may be able to address the limitations on performance described above without requiring an interface, whereby the EBS actively controls the LABS 132B. In this and the below the embodiments that define data communications with the EBS brake controller, the control pressure from the steer axle EPM can be connected to the pneumatic control port of the LABS 132B.

In another embodiment, the EBS can receive data from the LABS 132B and use that information to alter its control strategy based on the presence of the LABS 132B and liftable axle load information measured by the LABS 132B provided to the EBS via a data network. Again, the LABS 132B would not receive direct control instructions from the EBS.

In yet another embodiment, not only would the EBS receive data from the LABS 132B and use that information to alter its control strategy, but the EBS would also provide control instructions to the LABS 132B via a data network. In this case, the pneumatic connection between the steer axle and the LABS 132B may only function as a fail-safe to address conditions where the LABS 132B is faulted.

In another embodiment, the LABS 132B would not use wheel speed information for the controlled axles. Instead, the LABS 132B would use information about the vehicle operating state and EBS activity, optionally in combination with axle load information, to estimate the adhesion potential of the tires and perform a degree of slip regulation without wheel speed sensors installed on the controlled axles. This slip regulation would be entirely feed-forward, similar to the braking strategy employed during automated applications of the trailer brakes on air braked vehicles in North America.

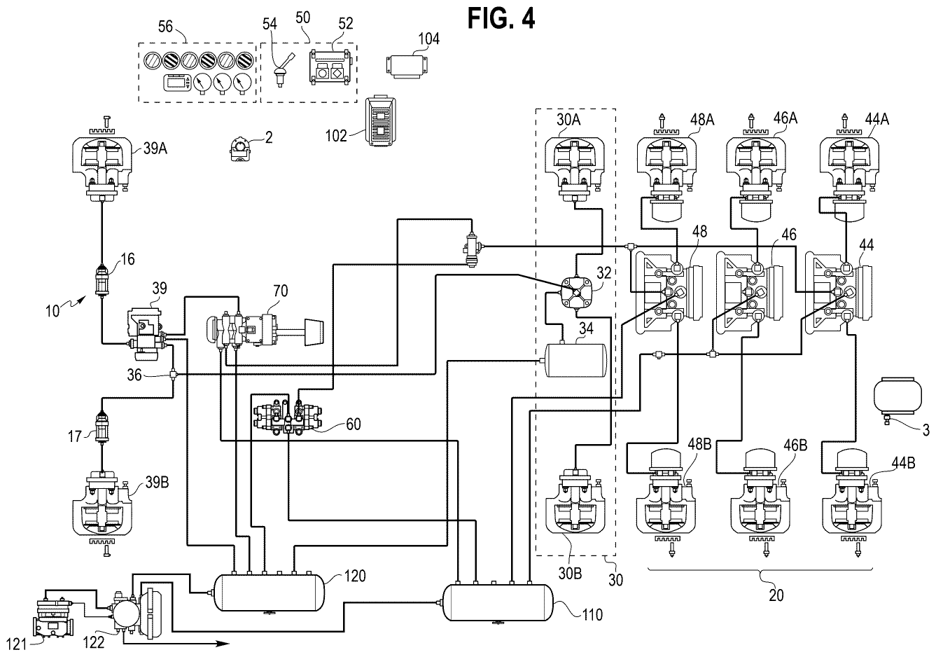

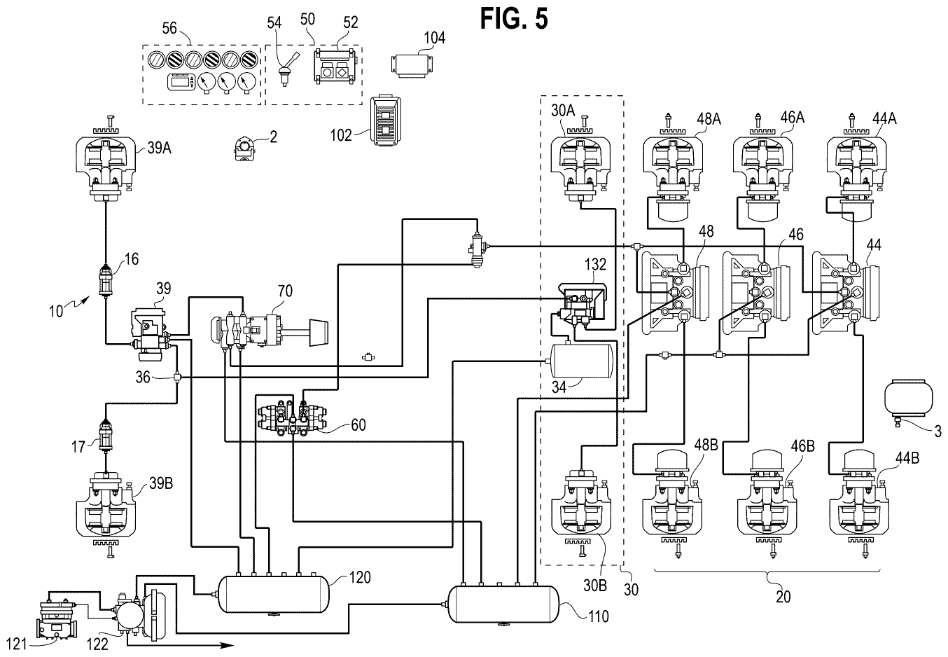

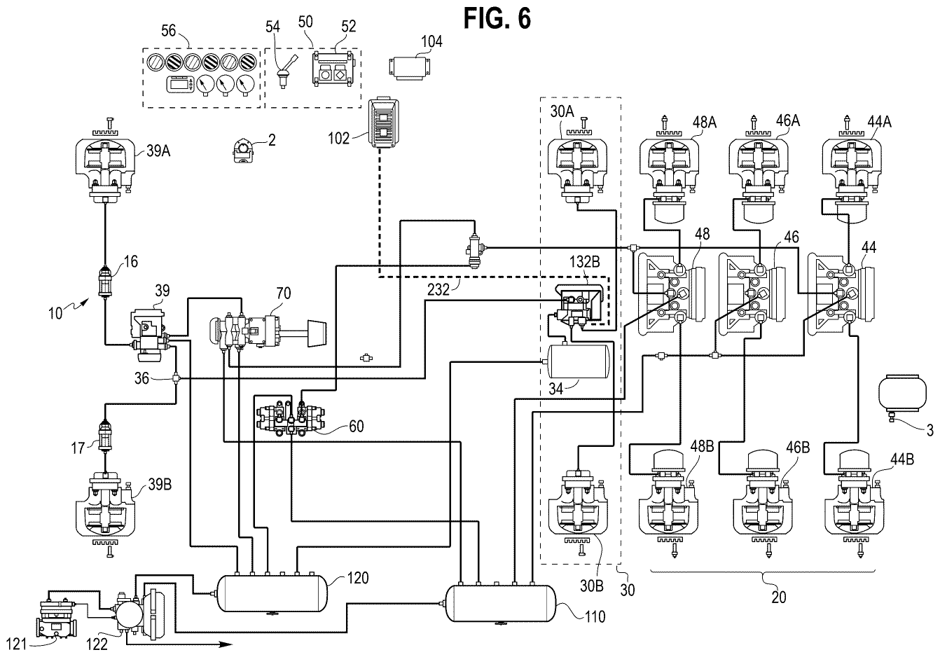

Many alternatives are possible. For example, while the vehicle in FIGS. 1-3 took the form of a towing vehicle capable of towing a towed vehicle, the lift axle braking system of these embodiments can be used with a truck that is not capable of towing a towed vehicle (e.g., a towing vehicle does not carry load without a towed vehicle, whereas a truck may carry load itself, in the absence of a towed vehicle). FIGS. 4-6 correspond to FIGS. 1-3 but are altered for used as a truck.

There are many advantages associated with these embodiments. For example, these embodiments can allow vehicles to be built in an OEM plant with lift axles, without adding EPMs or wheel speed sensors, or reconfiguring EBS parameters. These embodiments can also allow lift axles to be added to the vehicle later, without adding EPMs or wheel speed sensors, or reconfiguring parameters. Further, these embodiments can allow enhanced performance with towed vehicle or other ABS control on lift axles to be achieved, if desired.

### Conclusion

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A brake system comprising:
an electro-pneumatic module (EPM) configured to allow pressurized air to flow to a brake of a non-lift axle of a vehicle in response to movement of a brake pedal of the vehicle; and
a lift axle brake sub-system for a lift axle of the vehicle, the lift axle brake sub-system comprising:
at least one brake; and
a valve configured to selectively open to allow pressurized air to flow to the at least one brake of the lift axle of the vehicle;
wherein a control port of the valve is coupled with a delivery port of the EPM, and wherein the valve is configured to receive pressurized air from the EPM in response to movement of the brake pedal, which causes the valve to open and allow pressurized air to flow to the at least one brake of the lift axle of the vehicle; and
wherein the at least one brake of the lift axle of the vehicle is controlled to a same pressure provided to an anti-lock braking system (ABS) modulator on the non-lift axle of the vehicle.

2. The brake system of claim 1, wherein the valve comprises a relay valve.

3. The brake system of claim 1, further comprising a mechatronic valve configured to monitor data provided by an electronic braking system and alter control of the at least one brake of the lift axle of the vehicle in response to the monitored data.

4. The brake system of claim 1, wherein the vehicle comprises a truck.

5. The brake system of claim 1, wherein the vehicle comprises a tractor configured to tow a trailer.

6. A brake system comprising:
an electro-pneumatic module (EPM) configured to allow pressurized air to flow to a brake of a non-lift axle of a vehicle in response to movement of a brake pedal of the vehicle; and
a lift axle brake sub-system for a lift axle of the vehicle, the lift axle brake sub-system comprising:
at least one brake; and
a towed vehicle anti-lock brake system (TABS) comprising a valve configured to allow pressurized air to flow to the at least one brake of the lift axle of the vehicle;
wherein a control port of the TABS is coupled with a delivery port of the EPM, and wherein the TABS is configured to receive pressurized air from the EPM in response to movement of the brake pedal, which causes the TABS to allow pressurized air to flow to the at least one brake of the lift axle of the vehicle; and
wherein the TABS is configured to use an output of a wheel speed sensor on the non-lift axle of the vehicle to perform closed-loop slip control on the lift axle of the vehicle.

7. The brake system of claim 6, wherein the vehicle comprises a truck.

8. The brake system of claim 6, wherein the vehicle comprises a tractor configured to tow a trailer.

9. The brake system of claim 6, wherein the at least one brake of the lift axle of the vehicle is controlled to a same pressure provided to an anti-lock braking system (ABS) modulator on the non-lift axle of the vehicle.

10. A brake system comprising:
an electro-pneumatic module (EPM) configured to allow pressurized air to flow to a brake of a non-lift axle of the vehicle in response to movement of a brake pedal of a vehicle; and
a lift axle brake sub-system for a lift axle of the vehicle, the lift axle brake sub-system comprising:
at least one brake; and
a lift axle brake system (LABS) comprising a valve configured to allow pressurized air to flow to the at least one brake of the lift axle of the vehicle;
wherein a control port of the LABS is coupled with a delivery port of the EPM, and wherein the LABS is configured to receive pressurized air from the EPM in response to movement of the brake pedal, which causes the LABS to allow pressurized air to flow to the at least one brake of the lift axle of the vehicle; and
wherein the LABS is further configured to receive information from an electronic braking system controller and adjust application of the at least one brake on the lift axle in response to the information.

11. The brake system of claim 10, wherein the information comprises information about an operating condition of the vehicle.

12. The brake system of claim 10, wherein the information comprises information about electronic brake system activity.

13. The brake system of claim 10, wherein the LABS is further configured to prevent application of the at least one brake of the lift axle of the vehicle during a yaw control intervention.

14. The brake system of claim 10, wherein the LABS is further configured to receive vehicle speed information from the electronic braking system controller and use the vehicle speed information as a reference speed to enhance wheel-slip regulation.

15. The brake system of claim 10, wherein the LABS is configured to communicate with the electronic braking system controller via at least one data network on the vehicle.

16. The brake system of claim 10, wherein the electronic braking system controller is configured to receive liftable axle load information measured by the LABS and alter the electronic braking system controller's control strategy in response to the liftable axle load information.

17. The brake system of claim 10, wherein the electronic braking system controller is configured to send an electronic signal to the LABS to causes the LABS to allow pressurized air to flow to the at least one brake of the lift axle of the vehicle, and wherein the pressurized air that the LABS receives from the EPM functions as a fail-safe.

18. The brake system of claim 10, wherein the LABS is configured to estimate adhesion potential of tires and perform slip regulation without wheel speed sensors information.

19. The brake system of claim 10, wherein the vehicle comprises a truck.

20. The brake system of claim 10, wherein the vehicle comprises a tractor configured to tow a trailer.
